(19) United States
(12) Patent Application Publication
(10) Pub. No.: US 2023/0026188 A1
(43) Pub. Date: Jan. 26, 2023

(54) REMOTE SUPPORT DEVICE, REMOTE SUPPORT SYSTEM, AND REMOTE SUPPORT METHOD

(71) Applicant: Woven Planet Holdings, Inc., Tokyo (JP)

(72) Inventor: Daisuke ISO, Tokyo-to (JP)

(21) Appl. No.: 17/813,159

(22) Filed: Jul. 18, 2022

(30) Foreign Application Priority Data
Jul. 26, 2021 (JP) 2021-121916

(51) Int. Cl. G05D 1/00; B60W 40/02

(52) U.S. Cl. CPC G05D 1/0038; B60W 40/02; G05D 2201/0213

(57) ABSTRACT

A remote support device includes a data obtainment device, a data processing device, and a sound data reproduction device. The data obtainment device obtains various kinds of data including data on ambient sounds of the vehicle by communication with the vehicle. The data processing device processes various kinds of data including the data on ambient sounds. The sound data reproduction device reproduces sound data resulting from a process by the data processing device. The data processing device separates the data on an ambient sound into data on a vehicle sound which represent a sound produced accompanying an operation of the vehicle and data on an environmental sound which represent a sound produced in an environment around the vehicle. The data processing device outputs the data on the environmental sound to the sound data reproduction device.

The present disclosure claims priority under 35 U.S.C. § 119 to Japanese Patent Application No. 2021-121916, filed on Jul. 26, 2021, the contents of which application are incorporated herein by reference in their entirety.

### TECHNICAL FIELD

The present disclosure relates to a device, a system, and a method for remotely supporting traveling of a vehicle.

### BACKGROUND

JP 2018-77649 A discloses a system which performs remote driving of a vehicle. This system in the prior art includes a management facility where an operator performing remote driving (hereinafter, also referred to as “remote operator”) is stationed. The remote driving by the remote operator is started in response to a request from a vehicle. During the remote driving, various kinds of data are transmitted from the vehicle to the management facility. Various kinds of data include data on an ambient environment of the vehicle such as image data and sound data, which are obtained by in-vehicle equipment.

Because the remote driving is performed in the management facility distant from a vehicle, information on an ambient sound of the vehicle is important for a remote operator. However, a time lag due to communication occurs between the management facility and the vehicle. Thus, when data on an ambient sound obtained by a microphone of the vehicle are simply reproduced at the management facility, the time lag possibly gives discomfort to the remote operator. When the data on the ambient sound are reproduced without any change at the management facility, a sound unnecessary for remote driving possibly gives extra stresses to the remote operator as well.

One object of the present disclosure is to provide a technique capable of providing an ambient sound of a vehicle, which is obtained by a microphone of the vehicle, in a proper state for a remote operator in a case where traveling of the vehicle is remotely supported.

### SUMMARY

A first aspect of the present disclosure is a remote support device remotely supporting traveling of a vehicle, the remote support device having the following features.

The remote support device includes a data obtainment device, a data processing device, and a sound data reproduction device. The data obtainment device obtains various kinds of data including data on ambient sounds of the vehicle by communication with the vehicle. The data processing device processes various kinds of data including the data on ambient sounds. The sound data reproduction device reproduces sound data resulting from processing by the data processing device.

The data processing device is configured to:

separate the data on an ambient sound into data on a vehicle sound which represent a sound produced accompanying an operation of the vehicle and data on an environmental sound which represent a sound produced in an environment around the vehicle; and

output the data on the environmental sound to the sound data reproduction device.

A second aspect of the present disclosure further has the following features in the first aspect.

The remote support device further includes an input device and a vehicle sound database. The input device generates a support instruction for the vehicle in accordance with an input by an operator who performs the remote support and transmits the support instruction to the data processing device. Pseudo data on vehicle sounds produced accompanying operations of the vehicle are stored in the vehicle sound database for each kind of vehicle operation.

The data processing device is further configured to:

specify the kind of the vehicle operation which corresponds to the support instruction; and

output the pseudo data on the vehicle operation to the sound data reproduction device by referring to the vehicle sound database based on the vehicle operation of the specified kind.

A third aspect of the present disclosure further has the following features in the first aspect.

The remote support device further includes an abnormal sound database and an image data display device. Data on abnormal sounds produced in abnormalities of the vehicle are stored in the abnormal sound database. The image data display device displays image data.

The data processing device if further configured to:

determine whether or not data on an abnormal sound are included in the data on vehicle sounds by referring to the abnormal sound database based on the data on vehicle sounds; and

output icon data which indicate that an abnormal sound is produced to the image data display device in a case where the data processing device determines that the data on the abnormal sound are included in the data on vehicle sounds.

A fourth aspect of the present disclosure further has the following features in the first aspect.

The remote support device further includes an alarm sound database. Data on alarm sounds produced by emergency vehicles are stored in the alarm sound database.

The data processing device is further configured to:

determine whether or not data on an alarm sound are included in the data on environmental sounds by referring to the alarm sound database based on the data on environmental sounds; and

output the data on the alarm sound to the sound data reproduction device while amplifying the data on the alarm sound in a case where the data processing device determines that the data on the alarm sound are included in the data on environmental sounds.

A fifth aspect of the present disclosure further has the following features in the first aspect.

The remote support device further includes an alarm sound database. Data on alarm sounds produced by emergency vehicles are stored in the alarm sound database.

The data processing device is further configured to:

determine whether or not data on an alarm sound are included in the data on environmental sounds by referring to the alarm sound database based on the data on environmental sounds;

specify a kind of an emergency vehicle which corresponds to the data on the alarm sound in a case where the data processing device determines that the data on the alarm sound are included in the data on environmental sounds; and

output icon data which indicate that the emergency vehicle of the kind which corresponds to the alarm sound is present to the image data display device.

A sixth aspect of the present disclosure is a remote support system supporting traveling of a vehicle by a remote support device.

The vehicle includes a microphone, a data processing device, and a communication device. The microphone obtains data on ambient sounds of the vehicle. The data processing device of the vehicle processes various kinds of data including the data on ambient sounds. The communication device transmits data resulting from processing by the data processing device of the vehicle to the remote support device.

The remote support device includes a data obtainment device, a data processing device, and a sound data reproduction device. The data obtainment device obtains various kinds of data including the data on ambient sounds by communication with the vehicle. The data processing device executes processing for various kinds of data including the data on ambient sounds. The sound data reproduction device reproduces sound data resulting from a process by the data processing device.

The data processing device of the vehicle is configured to:

separate the data on an ambient sound into data on a vehicle sound which represent a sound produced accompanying an operation of the vehicle and data on an environmental sound which represent a sound produced in an environment around the vehicle; and

transmit the data on the environmental sound to the remote support device via the communication device.

The data processing device of the remote support device is configured to output the data on the environmental sound to the sound data reproduction device.

A seventh aspect of the present disclosure further has the following features in the sixth aspect.

The remote support device further includes an input device and a vehicle sound database. The input device generates a support instruction for the vehicle in accordance with an input by an operator who performs the remote support and transmits the support instruction to the data processing device. Pseudo data on vehicle sounds produced accompanying operations of the vehicle are stored in the vehicle sound database for each kind of vehicle operation.

The data processing device of the remote support device is further configured to:

specify a kind of a vehicle operation which corresponds to the support instruction; and

output the pseudo data on the vehicle operation to the sound data reproduction device by referring to the vehicle sound database based on the vehicle operation of the specified kind.

An eighth aspect of the present disclosure is a method of supporting traveling of a vehicle by a remote support device, the method having the following features.

The method includes the steps of:

obtaining data on ambient sounds of the vehicle;

separating the data on an ambient sound into data on a vehicle sound which represent a sound produced accompanying an operation of the vehicle and data on an environmental sound which represent a sound produced in an environment around the vehicle; and

outputting the data on the environmental sound from a sound data reproduction device of the remote support device.

A ninth aspect of the present disclosure further has the following features in the eighth aspect.

The method further includes the steps of:

generating a support instruction for the vehicle in accordance with an input by an operator who performs the remote support;

specifying a kind of a vehicle operation which corresponds to the support instruction; referring to a vehicle sound database, which stores pseudo data on vehicle sounds produced accompanying operations of the vehicle for each kind of vehicle operation, based on the vehicle operation of the specified kind; and

reading out pseudo data on the vehicle operation of the specified kind from the vehicle sound database and of reproducing the pseudo data from the sound data reproduction device.

According to the first, sixth or eighth aspect of the present disclosure, the data on an environmental sound are separated from the data on an ambient sound and are reproduced by the sound data reproduction device. In other words, the data on a vehicle sound separated from the data on the ambient sound are not reproduced by the sound data reproduction device. Consequently, it becomes possible to provide an ambient sound highly necessary for safe and smooth execution of remote support in a proper state for a remote operator.

According to the second, seventh or ninth aspect of the present disclosure, although the sound data reproduction device does not reproduce the data on the vehicle sound which are separated from the data on the ambient sound, the sound data reproduction device reproduces the pseudo data on the vehicle sound produced accompanying the vehicle operation, the vehicle operation corresponding to the support instruction generated in accordance with an input by the remote operator. Consequently, it becomes possible to provide a vehicle sound in a state where the remote operator does not feel discomfort.

According to the third aspect of the present disclosure, it becomes possible to cause the remote operator to recognize that an abnormality occurs in a case where an abnormal sound is included in a vehicle sound. This contributes to safe and smooth execution of the remote support.

According to the fourth or fifth aspect of the present disclosure, it becomes possible to cause the remote operator to recognize that an emergency vehicle is present around the vehicle in a case where an alarm sound of the emergency vehicle is included in an ambient sound. This contributes to safe and smooth execution of the remote support. In the fifth aspect of the present disclosure, it becomes possible to cause the remote operator to recognize the kind of an emergency vehicle.

### BRIEF DESCRIPTION OF DRAWINGS

FIG. 1 is a conceptual diagram for explaining remote support;

FIG. 2 is a diagram for explaining an outline of characteristic processing of a first embodiment;

FIG. 3 is a block diagram illustrating a configuration example of the vehicle illustrated in FIG. 1;

FIG. 4 is a diagram showing a configuration example of a facility that implements a second example of an automated order processing according to the first embodiment;

FIG. 5 is a block diagram illustrating a function configuration example of a data processing device of the automated order processing;

FIG. 6 is a diagram illustrating a function configuration example of the data processing device of the vehicle and that of the automated order processing;

FIG. 7 is a diagram for explaining an outline of characteristic processing of a second embodiment;

FIG. 8 is a schematic diagram illustrating one example of data to be displayed on an image data display device in a case where an abnormal noise is produced;

FIG. 9 is a block diagram illustrating a function configuration example of the data processing device of the automated order processing;

FIG. 10 is diagram for explaining an outline of characteristic processing of a third embodiment;

FIG. 11 is a schematic diagram illustrating one example of data to be displayed on the image data display device in a case where an emergency vehicle is present around the vehicle; and

FIG. 12 is a block diagram illustrating a function configuration example of the data processing device of the automated order processing.

### DESCRIPTION OF EMBODIMENT

A remote support device, a remote support system, and a remote support method according to embodiments of the present disclosure will hereinafter be described with reference to drawings. The remote support method according to the embodiments is realized by computer processing to be performed in the remote support system according to the embodiments. The same reference characters are given to the same or corresponding components in the drawings, and descriptions thereof will be simplified or will be skipped.

### First Embodiment

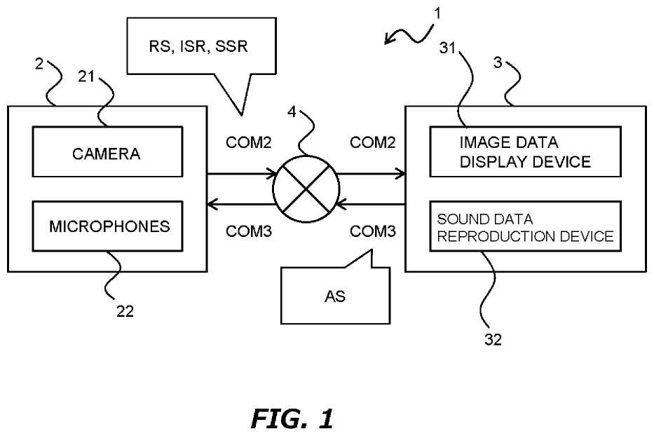

A first embodiment of the present disclosure will first be described with reference to FIGS. 1 to 6.

### 1. Outline of First Embodiment

### 1-1. Remote Support

FIG. 1 is a conceptual diagram for explaining remote support. A remote support system 1 illustrated in FIG. 1 includes a vehicle 2 as a target of remote support and a remote support device 3 which communicates with the vehicle 2. The remote support device 3 is provided to a management facility where a remote operator is stationed. Communication between the vehicle 2 and the remote support device 3 is performed via a network 4. In this communication, communication data COM2 are transmitted from the vehicle 2 to the remote support device 3. Meanwhile, communication data COM3 are transmitted from the remote support device 3 to the vehicle 2.

The vehicle 2 is an automobile which uses an internal combustion engine such as a diesel engine or a gasoline engine as a motive power source, an electric automobile which uses a motor as a motive power source, or a hybrid automobile which includes an internal combustion engine and a motor, for example. The motor is driven by a battery such as a secondary battery, a hydrogen fuel cell, a metal fuel cell, or an alcohol fuel cell.

The vehicle 2 travels by an operation by a driver of the vehicle 2. Traveling of the vehicle 2 may be performed by a control system installed in the vehicle 2. This control system supports traveling of the vehicle 2 based on the operation by the driver or performs control for autonomous traveling of the vehicle 2, for example. In a case where the driver or the control system determines that the remote support is necessary, the driver or the control system transmits a request signal RS for the remote support to the remote support device 3. The request signal RS is included in the communication data COM2.

The vehicle 2 includes a camera 21. The camera 21 photographs an image (movie) of surroundings of the vehicle 2. At least one camera 21 is provided to photograph an image of at least an area in front of the vehicle 2. The camera 21 for photographing the front area is provided to a back surface of a wind shield of the vehicle 2, for example. Data ISR on a surrounding image of the vehicle 2, which are obtained by the camera 21, are typically movie data. However, the data ISR may be still image data. The data ISR are included in the communication data COM2.

The vehicle 2 also includes directional microphones 22. Plural microphones 22 are provided to external side surfaces of a vehicle body. The microphones 22 are provided to a right front portion, a left front portion, a right rear portion, and a left rear portion of the vehicle body, for example.

Accordingly, the microphones 22 record an ambient sound of the vehicle 2. Data SSR on the ambient sound which is obtained by the microphones 22 are included in the communication data COM2. All of the data SSR may be included in the communication data COM2. Only a part of the data SSR may be included in the communication data COM2. In other words, all of the data SSR may be transmitted to the remote support device 3, or only a part of the data SSR may be transmitted to the remote support device 3.

In a case where the remote support device 3 accepts the request signal RS, the remote support device 3 remotely supports traveling of the vehicle 2 which transmits the request signal RS. The remote support device 3 includes an image data display device 31 and a sound data reproduction device 32. As the image data display device 31, a liquid crystal display (LCD) and an organic light-emitting diode (OLED) display may be raised as examples. In a case where the remote support device 3 accepts the request signal RS, the image data display device 31 displays the data ISR. As the sound data reproduction device 32, headphones and a speaker may be raised as examples. In a case where the remote support device 3 accepts the request signal RS, the sound data reproduction device 32 reproduces the data SSR.

The remote operator figures out an ambient environment of the vehicle 2 based on the data ISR displayed on the image data display device 31 and the data SSR reproduced by the sound data reproduction device 32 and inputs a support instruction for the vehicle 2. The remote support device 3 generates a support signal AS based on this support instruction and transmits the support signal AS to the vehicle 2. This support signal AS is included in the communication data COM3.

As the remote support by the remote operator, recognition support and assessment support may be raised as examples. Here, a case will be considered where autonomous driving control is performed by the control system of the vehicle 2. In a case where sunlight strikes a traffic light present in front of the vehicle 2, precision of recognition of a lighting state of light emitting portions of the traffic light is lowered. In a case where the lighting state cannot be recognized, it becomes difficult to assess what kind of behavior has to be executed at which timing. In such a case, recognition support of the lighting state and/or assessment support for behavior of the vehicle 2 are performed, the assessment support being based on the lighting state recognized by the remote operator.

The remote support by the remote operator also includes remote driving. In the remote driving, the remote operator recognizes an image displayed on the image data display device 31 or a sound reproduced by the sound data reproduction device 32 and performs a driving operation of the vehicle 2 which includes at least one of steering, acceleration, and deceleration. In this case, the support signal AS includes a signal which indicates a content of the driving operation of the vehicle 2. The control system of the vehicle 2 performs the driving operation of the vehicle 2, which includes at least one of steering, acceleration, and deceleration, in accordance with the support signal AS.

### 1-2. Characteristic Processing of First Embodiment

Information on the ambient sound of the vehicle 2 is information necessary for safe and smooth execution of the remote support by the remote operator. Here, the ambient sound includes a sound produced in an environment around the vehicle 2 (hereinafter, also referred to as “environmental sound”) and a sound produced accompanying an operation of the vehicle 2 (hereinafter, also referred to as “vehicle sound”).

As described above, a time lag due to communication occurs between the vehicle 2 and the management facility. That is, the vehicle sound during the remote support is obtained by the microphones 22 after a certain time elapses from an input of the support instruction by the remote operator. A certain time also elapses after this vehicle sound is obtained and until the data SSR are reproduced by the sound data reproduction device 32. Thus, when the vehicle sound obtained by the microphones 22 is reproduced without any change at the management facility, the time lag from the input of the support instruction to reproduction of the vehicle sound possibly gives discomfort to the remote operator. For example, due to a time lag from depression of an accelerator pedal to reproduction of an ascending sound of a revolution or rotation speed of a motive power source (engine or motor), the remote operator possibly misunderstands that a depression operation is insufficient.

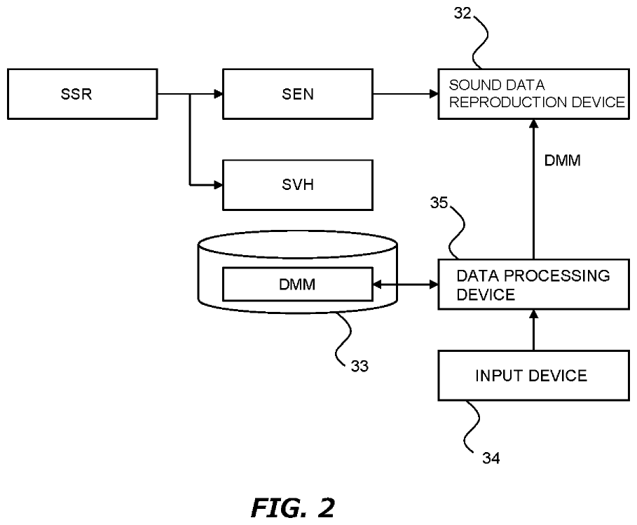

Accordingly, in the first embodiment, the ambient sound is separated into the environmental sound and the vehicle sound. FIG. 2 is a diagram for explaining an outline of characteristic processing of the first embodiment. The data SSR illustrated in FIG. 2 are data on the ambient sound obtained by the microphones 22. In the first embodiment, the data SSR are separated into data SEN on the environmental sound and data SVH on the vehicle sound. Then, the data SEN are reproduced by the sound data reproduction device 32. On the other hand, the data SVH are not reproduced by the sound data reproduction device 32. Accordingly, it becomes possible to inhibit the remote operator from feeling discomfort due to a time lag of the vehicle sound.

However, the remote operator possibly feels discomfort with a situation where the vehicle sound is not reproduced. Accordingly, in the first embodiment, instead of reproducing the data SVH, pseudo data DMM on the vehicle sound are reproduced by the sound data reproduction device 32. The pseudo data DIMM are stored in a database 33 of the management facility for each kind of vehicle operation.

Those vehicle operations include steering, acceleration, and deceleration. As sounds produced accompanying steering, a dry steering sound of a tire and a friction sound between a tire and a road surface may be raised as examples. As a sound produced accompanying acceleration, a revolution or rotation sound (ascending) of an engine or a motor may be raised as an example. As sounds produced accompanying deceleration, a revolution or rotation sound (descending) of an engine or a motor and a friction sound between a tire and a road surface may be raised as examples. The kinds of vehicle operations may further be combined with road surface states (dry and wet) or weather states (fine, raining, and snowing).

An output of the pseudo data DMM is performed based on the support instruction to be input to an input device 34 of the management facility. The input device 34 is a device to be operated by the remote operator and outputs data INS on the support instruction. The data INS are input to a data processing device 35 of the management facility. The data processing device 35 specifies the kind of the vehicle operation which corresponds to the support instruction based on the data INS. The data processing device 35 reads out the pseudo data DIMM corresponding to the specified kind from the database 33 and outputs the pseudo data DMM to the sound data reproduction device 32. Accordingly, the pseudo data DMM are reproduced by the sound data reproduction device 32.

In such a manner, in the first embodiment, the data SEN separated from the data SSR are reproduced by the sound data reproduction device 32. The pseudo data DMM read out from the database 33 are reproduced by the sound data reproduction device 32. Consequently, it becomes possible to provide the ambient sound obtained by the microphones 22 in a proper state for the remote operator.

The kind of the vehicle operation has to be specified based on the data INS in the remote support device 3 (input device 34). The pseudo data DMM corresponding to the specified kind have to be read out from the database 33 in the remote support device 3 also. On the other hand, the data SSR may be separated in the remote support device 3 (data processing device 35) or in the vehicle 2. A description will later be made about a configuration of the remote support device 3 in the former case and a configuration of the vehicle 2 in the latter case.

In the following, a remote support system according to the first embodiment will be described in detail.

### 2. Remote Support System

### 2-1. Configuration Example of Vehicle

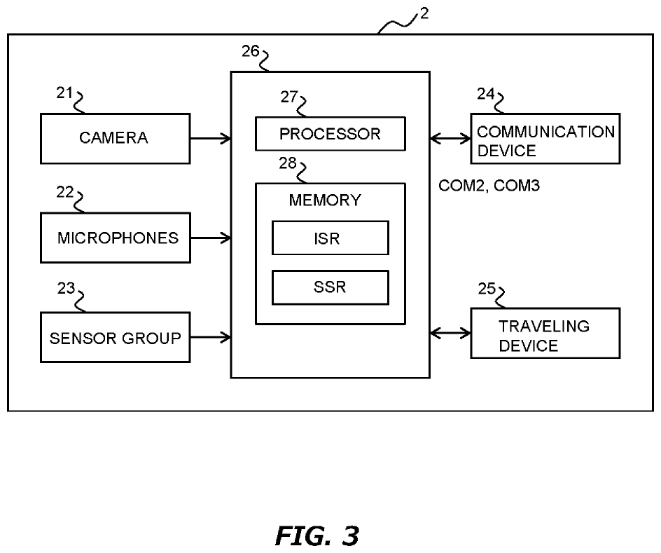

FIG. 3 is a block diagram illustrating a configuration example of the vehicle 2 illustrated in FIG. 1. As illustrated in FIG. 3, the vehicle 2 includes the camera 21, the microphones 22, a sensor group 23, a communication device 24, a traveling device 25, and a data processing device 26. Configuration elements such as the camera 21 and the microphones 22 and the data processing device 26 are connected together by an in-vehicle network (for example, a controller area network (CAN)), for example. The camera 21 and the microphones 22 have already been described in the description about FIG. 1.

The sensor group 23 includes state sensors which detect states of the vehicle 2. As the state sensors, a speed sensor, an acceleration sensor, a yaw rate sensor, and a steering angle sensor may be raised as examples. The sensor group 23 also includes position sensors which detect a position and a bearing of the vehicle 2. As the position sensor, a global navigation satellite system (GNSS) may be raised as an example. The sensor group 23 may further include recognition sensors other than the camera 21. A recognition sensor recognizes (detects) an ambient environment of the vehicle 2 by using an electric wave or light. As the recognition sensors, a millimeter-wave radar and laser imaging detection and ranging (LIDAR) may be raised as examples.

The communication device 24 performs wireless communication with a base station (not illustrated) of the network 4. As a communication standard of this wireless communication, a standard of mobile communication such as 4G, LTE, or 5G may be raised as an example. Connection destinations of the communication device 24 include the remote support device 3. In communication with the remote support device 3, the communication device 24 transmits the communication data COM2, which are received from the data processing device 26, to the remote support device 3.

The data processing device 26 is a computer for processing various kinds of data obtained by the vehicle 2. The data processing device 26 includes at least one processor 27 and at least one memory 28. The processor 27 includes a central processing unit (CPU). The memory 28 is a volatile memory such as a DDR memory. In the memory 28, a program to be used by the processor 27 is expanded, and various kinds of data are temporarily saved. Various kinds of data obtained by the vehicle 2 are stored in the memory 28. The various kinds of data include the above-described data ISR and SSR.

The processor 27 encodes the data ISR and SSR and outputs those to the communication device 24. In an encoding process, the data ISR and SSR may be compressed. The encoded data ISR and SSR are included in the communication data COM2. The encoding process of the data ISR and SSR may not be executed by using the processor 27 and the memory 28. For example, those processes may be executed by software processing by a graphics processing unit (GPU) or a digital signal processor (DSP) or by hardware processing by an ASIC or an FPGA.

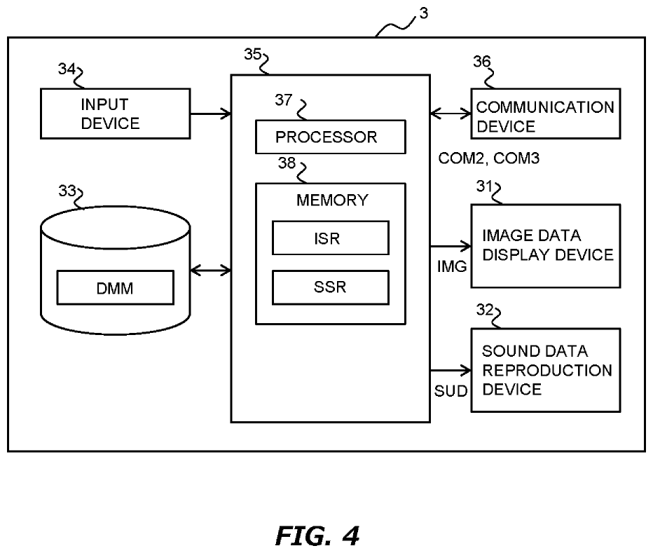

2-2. Configuration Example of Remote Facility FIG. 4 is a block diagram illustrating a configuration example of the remote support device 3 illustrated in FIG. 1. As illustrated in FIG. 4, the remote support device 3 includes the image data display device 31, the sound data reproduction device 32, the database 33, the input device 34, the data processing device 35, and a communication device 36. Configuration elements such as the image data display device 31 are connected with the data processing device 35 by a dedicated network. The image data display device 31 and the sound data reproduction device 32 have already been described in the description about FIG. 1.

The database 33 is a non-volatile storage medium such as a flash memory or a hard disk drive (HDD). The database 33 stores various kinds of programs and various kinds of data which are necessary for the remote support for traveling of the vehicle 2 (or remote driving of the vehicle 2). Various kinds of data include the pseudo data DMM.

The input device 34 is a device to be operated by the remote operator. The input device 34 includes an input unit which accepts the support instruction by the remote operator and a control circuit which generates and outputs the data INS based on this support instruction, for example. As input units, a touch panel, a mouse, a keyboard, a button, and a switch may be raised as examples. As inputs by the remote operator, a moving operation of a cursor displayed on the image data display device 31 and a selection operation of a button displayed on the image data display device 31 may be raised as examples.

In a case where the remote operator remotely drives the vehicle 2, the input device 34 may include input devices for traveling. As these input devices for traveling, a steering wheel, a shift lever, an accelerator pedal, and a brake pedal may be raised as examples.

The data processing device 35 is a computer for processing various kinds of data. The data processing device 35 includes at least one processor 37 and at least one memory 38. The processor 37 includes a CPU. The memory 38 expands a program to be used by the processor 37 and temporarily saves various kinds of data. The support instruction from the input device 34 and various kinds of data obtained by the remote support device 3 are stored in the memory 38. The various kinds of data include the data ISR and SSR which are obtained as the communication data COM2 by the remote support device 3.

The processor 37 decodes the data ISR and thereby performs an “image generation-display processing” for generating data IMG on an image to be displayed on the image data display device 31. In a case where the data ISR are compressed, the data ISR are decompressed in a decoding process. The processor 37 also outputs the generated data IMG to the image data display device 31.

The processor 37 decodes the data SSR and thereby performs a “sound generation-reproduction processing” for generating data SUD on a sound to be reproduced by the sound data reproduction device 32. Details of a sound generation process will be described later. In a case where the data SSR are compressed, the data SSR are decompressed in a decoding process. The processor 37 also outputs the generated data SUD to the sound data reproduction device 32.

The above-described decoding process, image generation-display processing, and sound generation-reproduction processing of the data ISR and SSR may not be executed by using the processor 37 or the memory 38. For example, those processes may be executed by software processing by a GPU or a DSP or by hardware processing by an ASIC or an FPGA.

The communication device 36 performs wireless communication with a base station of the network 4. As a communication standard of this wireless communication, a standard of mobile communication such as 4G, LTE, or 5G may be raised as an example. Communication destinations of the communication device 36 include the vehicle 2. In communication with the vehicle 2, the communication device 36 transmits the communication data COM3, which are received from the data processing device 35, to the vehicle 2.

### 2-3. Sound Generation-Reproduction Processing

### 2-3-1. First Example

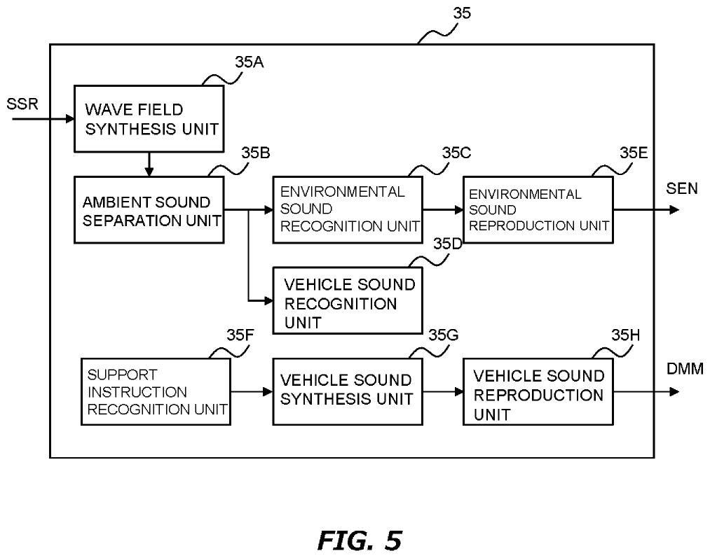

A description will be made, with reference to FIG. 5, about a first example of the sound generation-reproduction processing which is performed in the remote support system according to the first embodiment. FIG. 5 is a block diagram illustrating a function configuration example of the data processing device 35. In the example illustrated in FIG. 5, the data processing device 35 includes a wave field synthesis unit 35A, an ambient sound separation unit 35B, an environmental sound recognition unit 35C, a vehicle sound recognition unit 35D, an environmental sound reproduction unit 35E, a support instruction recognition unit 35F, a vehicle sound synthesis unit 35G, and a vehicle sound reproduction unit 35H. Functions of the units 35A to 35H are realized by reading out predetermined programs from the memory 38 and executing the predetermined programs by the processor 37 of the data processing device 35.

The wave field synthesis unit 35A performs wave field synthesis using the data SSR which are received as the communication data COM2 by the remote support device 3. The data SSR include data SSRk (1≤k≤N and N denotes the total number of microphones 22) of a recorded sound in each direction. When the wave field synthesis of the data SSRk is performed, sound data are generated which reproduce a sense of directions around the vehicle 2. A known procedure can be applied to the wave field synthesis. One example may be a procedure of acoustic wave field synthesis, which is disclosed in the following literature. This procedure synthesizes a wave field extremely close to an actual sound field by using the Kirchhoff-Helmholtz integral.
Berkhout A J et al., “Acoustic control by wave field synthesis”, Journal of the Acoustical Society of America. 1993, 93(5): 2764-2778.

The ambient sound separation unit 35B separates sound data generated by the wave field synthesis unit 35A into the data SEN and the data SVH. As described above, the data SEN are data which represent a sound produced in an environment around the vehicle 2. The data SVH are data on a sound produced accompanying an operation of the vehicle 2. The former is transmitted to the environmental sound recognition unit 35C, and the latter is transmitted to the vehicle sound recognition unit 35D. A known procedure can be applied to separation of sound data. One example may be a procedure disclosed in the following literature. This procedure separates sound data by using a model constructed by learning in which two kinds of sound data are used as training data.
J. R. Hershey, et al., “Deep clustering: Discriminative embeddings for segmentation and separation”, Proc. ICASSP 2016, pp. 31-35 (2016).

The environmental sound recognition unit 35C analyzes the data SEN received from the ambient sound separation unit 35B and recognizes the kind of the environmental sound included in the data SEN. As environmental sounds as recognition targets, an alarm sound made by a railroad crossing or a traffic light, an alarm sound made by an emergency vehicle, a warning sound made by a vehicle around the vehicle 2, and so forth may be raised as examples. A known procedure can be applied to recognition of an environmental sound. One example may be a procedure disclosed in the following literature. This procedure realizes recognition of an audio pattern by using a pretrained audio neural network (PANN) which is modeled by a convolution neural network.
Qiuqiang Kong al., “PANNs: Large-Scale Pretrained Audio Neural Networks for Audio Pattern Recognition”, arXiv preprint arXiv: 1912. 10211 (2019).

The vehicle sound recognition unit 35D analyzes the data SVH received from the ambient sound separation unit 35B and recognizes the kind of the vehicle sound included in the data SVH. A vehicle sound as a target to be recognized is a sound produced accompanying steering, acceleration, or deceleration. As sounds produced accompanying steering, a dry steering sound of a tire and a friction sound between a tire and a road surface may be raised as examples. As a sound produced accompanying acceleration, a revolution or rotation sound (ascending) of an engine or a motor may be raised as an example. As sounds produced accompanying deceleration, a revolution or rotation sound (decreasing) of an engine or a motor and a friction sound between a tire and a road surface may be raised as examples. A known procedure can be applied to recognition of a vehicle sound. One example may be a procedure disclosed in the following literature.
Marchi Erik et al., “A novel approach for automatic acoustic novelty detection using a denoising autoencoder with bidirectional LSTM neural networks”, IEEE International Conference on Acoustics, Speech and Signal Processing (ICASSP) (2015).

The environmental sound reproduction unit 35E reproduces the data SEN based on the kind of the environmental sound recognized by the environmental sound recognition unit 35C. The environmental sound reproduction unit 35E analyzes frequencies of the environmental sound of the recognized kind and increases a sound volume gain of a specific frequency, for example. Accordingly, the data SEN are reproduced in a state where the environmental sound of the recognized kind is amplified. In a case where no environmental sound of a specific kind is recognized, the environmental sound reproduction unit 35E reproduces the data SEN while removing noises by using a filter, for example.

The support instruction recognition unit 35F recognizes the kind of the support instruction (vehicle operation) based on the data INS on the support instruction input from the input device 34 to the data processing device 35. For example, in a case where depression data on an accelerator pedal (or a brake pedal), which are input to the data processing device 35, are changed, the support instruction recognition unit 35F recognizes that an acceleration instruction (or a deceleration instruction) is made. The degree (normal, slow, or rapid) of the support instruction may be recognized based on the change rate of the depression data. In a case where data on a steering angle torque, which are input to the data processing device 35, are changed, the support instruction recognition unit 35F recognizes that a steering instruction is made.

The vehicle sound synthesis unit 35G synthesizes a vehicle sound based on the kind and degree of the support instruction recognized by the support instruction recognition unit 35F. The vehicle sound synthesis unit 35G first refers to the database 33 and thereby specifies the pseudo data DMM corresponding to the kind of the recognized support instruction. The specified pseudo data DMM are read out from the database 33. For example, in a case where the acceleration instruction is recognized, data on a revolution or rotation sound (ascending) of an engine or a motor are read out. In a case where the deceleration instruction is recognized, data on a revolution or rotation sound (descending) of an engine or a motor are read out. In a case where the steering instruction is recognized, data on a dry steering sound of a tire or of a friction sound between a tire and a road surface are read out. In a case where the pseudo data DIMM corresponding to the degree of the support instruction is specified, the pseudo data DMM are read out from the database 33. The vehicle sound synthesis unit 35G then synthesizes the pseudo data DMM which are read out and transmits the pseudo data DMM to the vehicle sound reproduction unit 35H.

The vehicle sound reproduction unit 35H reproduces synthesized sound data (pseudo data DMM) received from the vehicle sound synthesis unit 35G. A time needed for synthesis of the pseudo data DMM after the input of the data INS is extremely short, although depending on the processing capacity of the processor. Consequently, the synthesized sound data are reproduced while being synchronized with the input of the data INS.

The vehicle sound reproduction unit 35H changes the sound volume of the synthesized sound data in accordance with the data SEN reproduced by the environmental sound reproduction unit 35E. The sound volume of the synthesized sound data may be changed in accordance with the kind of the data SEN. For example, in a case where the data SEN are reproduced in a state where the sound volume of the environmental sound of a preset kind is increased, the vehicle sound reproduction unit 3511 decreases the sound volume of the synthesized sound data. Accordingly, it becomes possible to inhibit reproduction of the synthesized sound data from becoming a noise and hindering recognition of the environmental sound of the preset kind.

### 2-3-2. Second Example

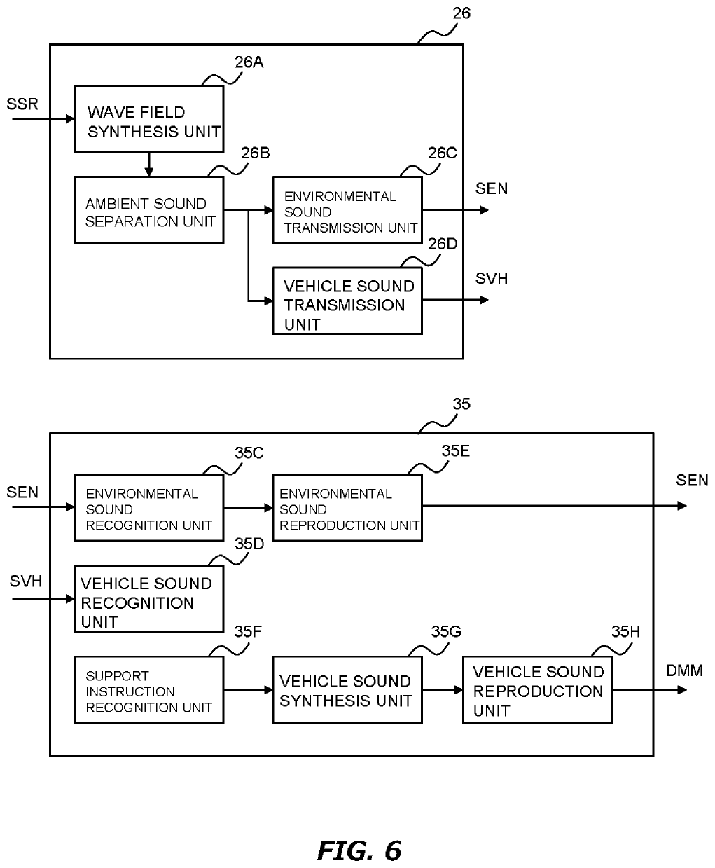

Next, a description will be made, with reference to FIG. 6, about a second example of the sound generation-reproduction processing which is performed in the remote support system according to the first embodiment. FIG. 6 is a diagram illustrating a function configuration example of the data processing devices 26 and 35.

In the example illustrated in FIG. 6, the data processing device 26 includes a wave field synthesis unit 26A, an ambient sound separation unit 26B, an environmental sound transmission unit 26C, and a vehicle sound transmission unit 26D. Functions of the units 26A to 26D are realized by reading out predetermined programs from the memory 28 and executing the predetermined programs by the processor 27 of the data processing device 26.

A configuration of the wave field synthesis unit 26A is the same as that of the wave field synthesis unit 35A which is described in the first example. A configuration of the ambient sound separation unit 26B is the same as that of the ambient sound separation unit 35B which is described in the first example. The environmental sound transmission unit 26C transmits the data SEN received from the ambient sound separation unit 26B to the remote support device 3. The environmental sound transmission unit 26C receives the data SEN from the ambient sound separation unit 35B and transmits the data SEN to the communication device 24. The vehicle sound transmission unit 26D receives the data SVH from the ambient sound separation unit 26B and transmits the data SVH to the communication device 24. In other words, in the second example, the data SEN and SVH are separately transmitted as the communication data COM2 to the remote support device 3.

In the example illustrated in FIG. 6, the data processing device 35 includes the environmental sound recognition unit 35C, the vehicle sound recognition unit 35D, the environmental sound reproduction unit 35E, the support instruction recognition unit 35F, the vehicle sound synthesis unit 35G, and the vehicle sound reproduction unit 35H. Those units 35C to 35H have configurations in common with those of the first example.

In such a manner, in the second example, a part of processing of the sound generation-reproduction processing are performed by the data processing device 26, the sound generation-reproduction processing being performed by the data processing device 35 in the first example.

### 2-3-3. Third and Fourth Examples

In the first embodiment, although the data SVH are analyzed, results of this analysis are not output to the outside of the data processing device 35. Accordingly, in a third example of the first embodiment, the vehicle sound recognition unit 35D is omitted from the first example described with reference to FIG. 5 or the second example described with reference to FIG. 6. Further, transmission of the data SVH becomes unnecessary. Accordingly, in a fourth example of the first embodiment, the vehicle sound transmission unit 26D and the vehicle sound recognition unit 35D are omitted from the second example described with reference to FIG. 6. In other words, in the fourth example, only the data SEN are transmitted as the communication data COM2 to the remote support device 3.

### 3. Effects

In the first embodiment, the data SEN (in other words, the data on the environmental sound) are separated from the data SSR (in other words, the data on the ambient sound) obtained by the microphones 22 and are reproduced by the sound data reproduction device 32. On the other hand, the data SVH (the data on the vehicle sound) separated from the data SSR are not reproduced by the sound data reproduction device 32. Instead, the pseudo data DMM (pseudo data on the vehicle sound) are read out from the database 33 based on the data INS input from the input device 34 to the data processing device 35 and are reproduced by the sound data reproduction device 32. Consequently, it becomes possible to provide the ambient sound obtained by the microphones 22 in a proper state for the remote operator.

### Second Embodiment

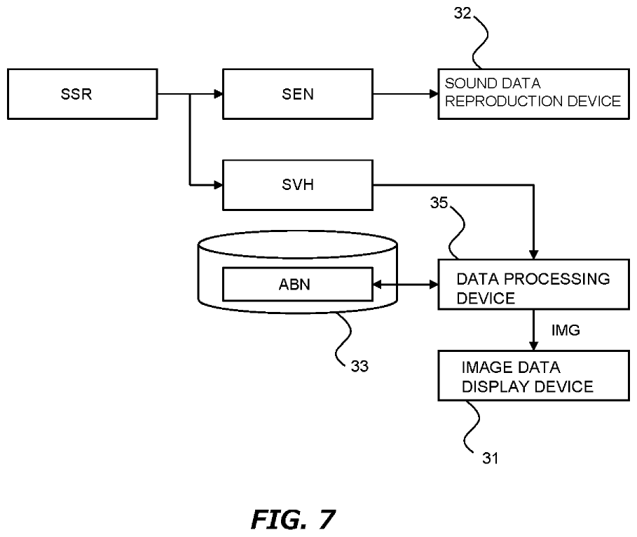

A second embodiment of the present disclosure will next be described with reference to FIGS. 7 to 9. Descriptions in common with the first embodiment will appropriately be skipped.

### 1. Characteristic Processing of Second Embodiment

FIG. 7 is a diagram for explaining an outline of characteristic processing of the second embodiment. The data SSR, SEN, and SVH illustrated in FIG. 7 are in common with those in the first embodiment. In the second embodiment, the data processing device 35 analyzes the data SVH. To this point, the processing is the same as the first embodiment. In the second embodiment, it is determined whether or not data ABN are included in the data SVH by referring to the database 33 based on results of the analysis of the data SVH.

The data ABN are data on a sound produced in abnormalities of the vehicle (abnormal sound) and are registered in the database 33 for each kind of abnormal sound. As kinds of abnormal sounds, driving system anomalous sounds, brake anomalous sounds, and power steering anomalous sounds may be raised as examples. The driving system anomalous sound is an anomalous sound produced between a transmission and differential gears. The brake anomalous sound is an anomalous sound produced in a brake mechanism or portions around that. The power steering anomalous sound is an anomalous sound produced when a power steering is actuated.

In the second embodiment, in a case where it is determined that any kind of data on the abnormal sound is included in the data SVH, an abnormal sound notification processing is performed. The abnormal sound notification processing is processing to notify the remote operator that the abnormal sound is produced in the vehicle 2. In the abnormal sound notification processing, a notification signal is generated which indicates that the abnormal sound is produced in the vehicle 2, for example. Based on this notification signal, icon data indicating production of the abnormal sound are then superimposed on a predetermined region of the data IMG generated in the image generation-display processing.

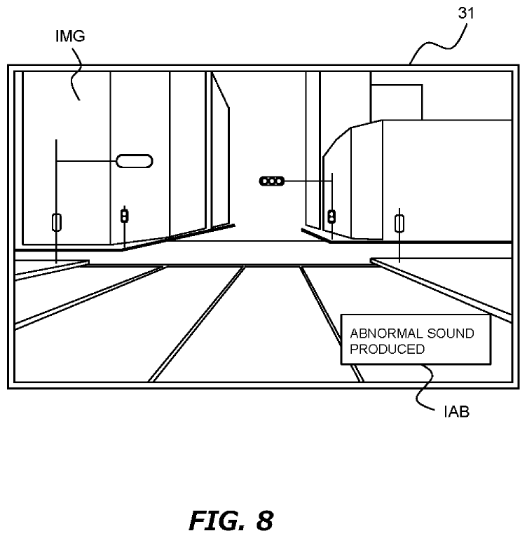

FIG. 8 is a schematic diagram illustrating one example of the data IMG to be displayed on the image data display device 31 in a case where the abnormal noise is produced. In the example illustrated in FIG. 8, the image data display device 31 displays the data IMG on which icon data LAB of “ABNORMAL SOUND PRODUCED” are superimposed on the predetermined region in a lower right part. The icon data IAB are in advance registered in the database 33. Such data IMG are displayed, and it thereby becomes possible for the remote operator to recognize that an abnormality occurs to the vehicle 2.

In the second embodiment, the kind of the abnormal sound may be specified based on the data ABN included in the data SVH. In this case, in the abnormal sound notification processing, a notification signal is generated which corresponds to the specified kind of abnormal sound. Then, in the image generation-display processing based on this notification signal, the icon data corresponding to the specified kind of abnormal sound are superimposed on the predetermined region. As the icon data in this case, “driving system anomalous sound produced”, “brake anomalous sound produced”, and “power steering anomalous sound produced” may be raised as examples.

### 2. Function Configuration Example of Data Processing Device 35

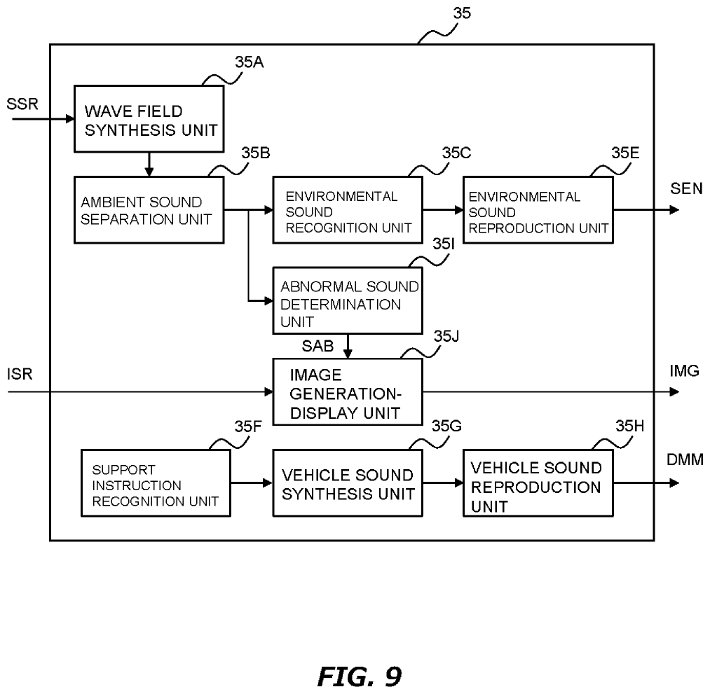

FIG. 9 is a block diagram illustrating a function configuration example of the data processing device 35. In the example illustrated in FIG. 9, the data processing device 35 includes an abnormal sound determination unit 35I instead of the vehicle sound recognition unit 35D described with reference to FIG. 5. In the example illustrated in FIG. 9, the data processing device 35 further includes an image generation-display unit 35J. Functions of the units 35A to 35C and 35E to 35J are realized by reading out predetermined programs from the memory 38 and executing the predetermined programs by the processor 37 of the data processing device 35.

The abnormal sound determination unit 35I analyzes the data SVH received from the ambient sound separation unit 35B and recognizes the kind of the vehicle sound included in the data SVH. A vehicle sound as a target to be recognized is a sound produced in an abnormality of the vehicle (abnormal sound). As abnormal sounds as recognition targets, driving system anomalous sounds, brake anomalous sounds, and power steering anomalous sounds may be raised as examples. As a procedure of recognizing an abnormal sound, a known procedure is applied in the same manner as a procedure of recognizing a vehicle sound by the vehicle sound recognition unit 35D, which is described with reference to FIG. 5. One example may be a procedure disclosed in the following literature.
Hisashi Uematsu et al., “Anomaly Detection Technique in Sound to Detect Faulty Equipment”, The Telecommunications Association, NTT Technical Journal 29(6), 24-27, 2017-06.
Kaori Suefusa et al., “Anomalous sound detection based on interpolation deep neural network”, arXiv: 2005.09234 [eess.AS] (2020).

In a case where the abnormal sound determination unit 35I recognizes any kind of abnormal sound, the abnormal sound determination unit 35I outputs a signal (hereinafter, also referred to as “abnormal sound notification signal”) SAB to notify that an abnormal sound is produced in the vehicle 2 to the image generation-display unit 35J. The abnormal sound determination unit 35I may specify the kind of the recognized abnormal sound. In this case, the abnormal sound determination unit 35I outputs the abnormal sound notification signal SAB corresponding to the specified kind of abnormal sound to the image generation-display unit 35J.

The image generation-display unit 35J performs the image generation-display processing. In the image generation-display processing, the data ISR are decoded, and the data IMG are generated. As described above, the data IMG are data on an image to be displayed on the image data display device 31. In the image generation-display processing, a display content of the image data display device 31 is controlled. In the control of the display content, for example, based on a signal input from the input device 34, the display content is enlarged or shrunk, or a switch (transition) of display contents is performed. In another example of the control of the display content, based on the input signal, a cursor displayed on the image data display device 31 is moved, or a button displayed on the image data display device 31 is selected.

In a case where the image generation-display unit 35J receives the abnormal sound notification signal SAB, the image generation-display unit 35J generates the data IMG while superimposing the icon data IAB indicating production of the abnormal sound on a predetermined region of the data IMG. In a case where the kind of the abnormal sound is specified in the abnormal sound notification signal SAB, the image generation-display unit 35J generates the data IMG while superimposing the icon data IAB corresponding to the specified kind of abnormal sound on the data IMG. The image generation-display unit 35J may display the icon data IAB on another image data display device 31 than the image data display device 31 which displays the data IMG. In this case, the icon data IAB is alone displayed on this other image data display device 31.

### 3. Effects

In the second embodiment, in a case where the data ABN (in other words, the data on the abnormal sound) are included in the data SVH (in other words, the data on the vehicle sound), the icon data IAB are displayed on the image data display device 31. Consequently, it becomes possible to cause the remote operator to recognize that an abnormality occurs to the vehicle 2. This contributes to safe and smooth execution of the remote support by the remote operator.

### Third Embodiment

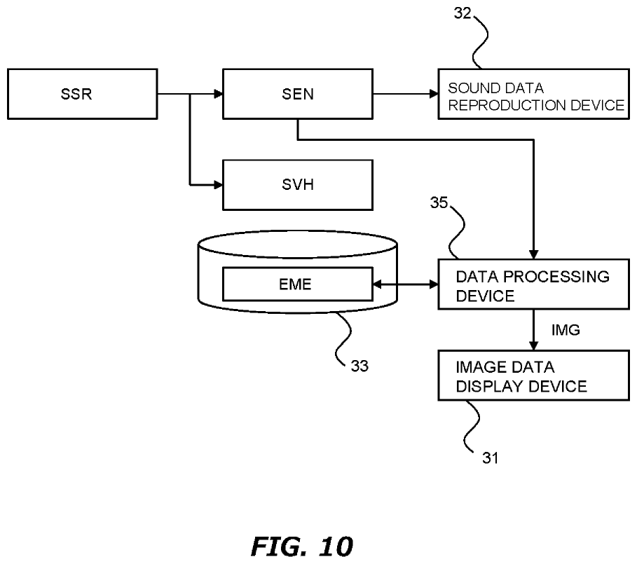

A third embodiment of the present disclosure will next be described with reference to FIGS. 10 to 12. Descriptions in common with the first or second embodiment will appropriately be skipped.

### 1. Characteristic Processing of Third Embodiment

FIG. 10 is a diagram for explaining an outline of characteristic processing of the third embodiment. The data SSR, SEN, and SVH illustrated in FIG. 10 are in common with those in the first embodiment. In the third embodiment, the data processing device 35 analyzes the data SEN. To this point, the processing is the same as the first embodiment. In the third embodiment, it is determined whether or not data EME are included in the data SEN by referring to the database 33 based on results of the analysis of the data SEN.

The data EME are data on an alarm sound produced by an emergency vehicle and are registered in the database 33 for each kind of emergency vehicle. As emergency vehicles, police vehicles, fire engines, and ambulances may be raised as examples.

In the third embodiment, in a case where it is determined that any kind of data on the emergency vehicle is included in the data SEN, an emergency vehicle notification processing is performed. The emergency vehicle notification processing is processing to notify the remote operator that an emergency vehicle is present around the vehicle 2. In the emergency vehicle notification processing, for example, in order to amplify the alarm sound, a notification signal is generated which increases the sound volume gain of a specific frequency configuring the alarm sound. The alarm sound is amplified, and it thereby becomes possible for the remote operator to recognize that an emergency vehicle is present around the vehicle 2.

In another example of the emergency vehicle notification processing, a notification signal is generated which indicates that a specific kind of emergency vehicle is present. Based on this notification signal, icon data indicating presence of the specific kind of emergency vehicle are then superimposed on a predetermined region of the data IMG generated in the image generation-display processing.

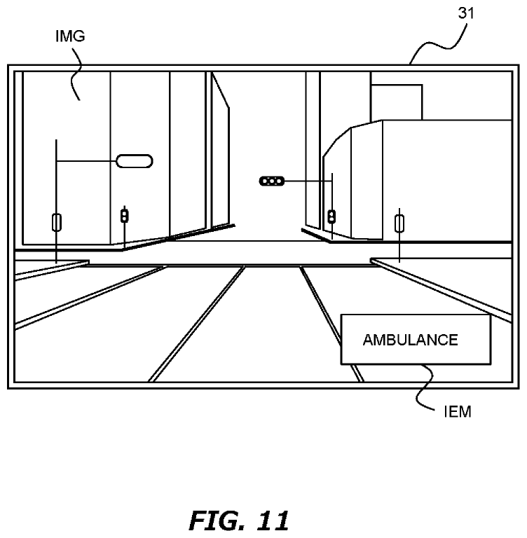

FIG. 11 is a schematic diagram illustrating one example of the data IMG to be displayed on the image data display device 31 in a case where an emergency vehicle is present around the vehicle 2. In the example illustrated in FIG. 11, the image data display device 31 displays the data IMG on which icon data IEM of “AMBULANCE” are superimposed on the predetermined region in a lower right part. The icon data IEM are in advance registered in the database 33. Such data IMG are displayed, and it thereby becomes possible for the remote operator to recognize that an emergency vehicle is present around the vehicle 2.

### 2. Function Configuration Example of Data Processing Device 35

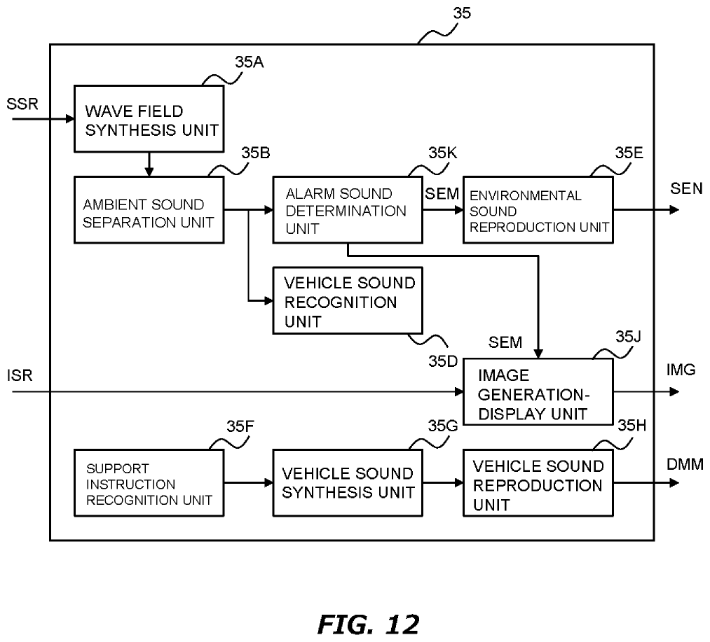

FIG. 12 is a block diagram illustrating a function configuration example of the data processing device 35. In the example illustrated in FIG. 12, the data processing device 35 includes an alarm sound determination unit 35K instead of the environmental sound recognition unit 35C described with reference to FIG. 5. In the example illustrated in FIG. 12, the data processing device 35 further includes the image generation-display unit 35J. Functions of the units 35A, 35B, 35D to 35H, 35J, and 35K are realized by reading out predetermined programs from the memory 38 and executing the predetermined programs by the processor 37 of the data processing device 35.

The alarm sound determination unit 35K analyzes the data SEN received from the ambient sound separation unit 35B and recognizes the kind of the environmental sound included in the data SEN. An environmental sound as a target to be recognized is an alarm sound produced by an emergency vehicle. As alarm sounds as recognition targets, police vehicle sounds, fire engine sounds, and ambulance sounds may be raised as examples. As a procedure of recognizing an alarm sound, a known procedure is applied in the same manner as a procedure of recognizing an environmental sound by the environmental sound recognition unit 35C, which is described with reference to FIG. 5. In a case where the alarm sound determination unit 35K recognizes any kind of alarm sound, the alarm sound determination unit 35K outputs a signal (hereinafter, also referred to as “emergency vehicle notification signal”) SEM to notify that a specific emergency vehicle is present around the vehicle 2 to the environmental sound reproduction unit 35E and the image generation-display unit 35J.

The environmental sound reproduction unit 35E reproduces the data SEN based on the kind of the environmental sound recognized by the environmental sound recognition unit 35C. To this point, the processing is the same as the first embodiment. In a case where the environmental sound reproduction unit 35E receives the emergency vehicle notification signal SEM, the environmental sound reproduction unit 35E increases the sound volume gain of a specific frequency configuring the alarm sound. Accordingly, the data SEN are reproduced in a state where the recognized alarm sound is amplified.

The image generation-display unit 35J performs the image generation-display processing. To this point, the processing is the same as the second embodiment. In a case where the image generation-display unit 35J receives the emergency vehicle notification signal SEM, the image generation-display unit 35J generates the data IMG while superimposing the icon data IEM indicating presence of the specific kind of emergency vehicle on a predetermined region of the data IMG. The image generation-display unit 35J may display the icon data IEM on another image data display device 31 than the image data display device 31 which displays the data IMG. In this case, the icon data IEM is alone displayed on this other image data display device 31.

### 3. Effects

In the third embodiment, in a case where the data SEN (in other words, the data on the environmental sound) include the data EME (in other words, the data on the alarm sound), the alarm sound is reproduced from the sound data reproduction device 32 in a state where the alarm sound is amplified. Alternatively, the icon data IEM are displayed on the image data display device 31. Consequently, it becomes possible to cause the remote operator to recognize that an emergency vehicle is present around the vehicle 2. This contributes to safe and smooth execution of the remote support by the remote operator.

What is claimed is:

1. A remote support device remotely supporting traveling of a vehicle, comprising:
a data obtainment device configured to obtain various kinds of data including data on ambient sounds of the vehicle by communication with the vehicle;
a data processing device configured to process various kinds of data including the data on ambient sounds; and
a sound data reproduction device configured to reproduce sound data resulting from processing by the data processing device,
wherein the data processing device is configured to:
separate the data on an ambient sound into data on a vehicle sound which represent a sound produced accompanying an operation of the vehicle and data on an environmental sound which represent a sound produced in an environment around the vehicle; and
output the data on the environmental sound to the sound data reproduction device.

2. The remote support device according to claim 1, further comprising:
an input device configured to generate a support instruction for the vehicle in accordance with an input by an operator who performs the remote support and to transmit the support instruction to the data processing device; and
a vehicle sound database in which pseudo data on vehicle sounds produced accompanying operations of the vehicle are stored for each kind of vehicle operation,
wherein the data processing device is further configured to:
specify the kind of the vehicle operation which corresponds to the support instruction; and
output the pseudo data on the vehicle operation to the sound data reproduction device by referring to the vehicle sound database based on the vehicle operation of the specified kind.

3. The remote support device according to claim 1, further comprising:
an abnormal sound database in which data on abnormal sounds produced in abnormalities of the vehicle are stored; and
an image data display device configured to display image data,
wherein the data processing device if further configured to:
determine whether or not data on an abnormal sound are included in the data on vehicle sounds by referring to the abnormal sound database based on the data on vehicle sounds; and
output icon data which indicate that an abnormal sound is produced to the image data display device in a case where the data processing device determines that the data on the abnormal sound are included in the data on vehicle sounds.

4. The remote support device according to claim 1, further comprising:
an alarm sound database in which data on alarm sounds produced by emergency vehicles are stored;
wherein the data processing device is further configured to:
determine whether or not data on an alarm sound are included in the data on environmental sounds by referring to the alarm sound database based on the data on environmental sounds; and
output the data on the alarm sound to the sound data reproduction device while amplifying the data on the alarm sound in a case where the data processing device determines that the data on the alarm sound are included in the data on environmental sounds.

5. The remote support device according to claim 1, further comprising:
an alarm sound database in which data on alarm sounds produced by emergency vehicles are stored;
wherein the data processing device is further configured to:
determine whether or not data on an alarm sound are included in the data on environmental sounds by referring to the alarm sound database based on the data on environmental sounds;
specify a kind of an emergency vehicle which corresponds to the data on the alarm sound in a case where the data processing device determines that the data on the alarm sound are included in the data on environmental sounds; and
output icon data which indicate that the emergency vehicle of the kind which corresponds to the alarm sound is present to the image data display device.

6. A remote support system supporting traveling of a vehicle by a remote support device,
wherein the vehicle includes:
a microphone;
a data processing device configured to process various kinds of data including the data on ambient sounds; and
a communication device configured to transmit data resulting from processing by the data processing device of the vehicle to the remote support device,
wherein the remote support device includes:
a data obtainment device configured to obtain various kinds of data including the data on ambient sounds by communication with the vehicle;
a data processing device configured to execute processing for various kinds of data including the data on ambient sounds; and
a communication device configured to transmit data resulting from processing by the data processing device of the vehicle to the remote support device,
wherein the data processing device of the vehicle is configured to:
separate the data on an ambient sound into data on a vehicle sound which represent a sound produced accompanying an operation of the vehicle and data on an environmental sound which represent a sound produced in an environment around the vehicle; and
transmit the data on the environmental sound to the remote support device via the communication device,
wherein the data processing device of the remote support device is configured to output the data on the environmental sound to the sound data reproduction device.

7. The remote support system according to claim 6,
wherein the remote support device further includes:
an input device configured to generate a support instruction for the vehicle in accordance with an input by an operator who performs the remote support and transmits the support instruction to the data processing device; and
a vehicle sound database in which pseudo data on vehicle sounds produced accompanying operations of the vehicle are stored for each kind of vehicle operation,
wherein the data processing device of the remote support device is further configured to:
specify a kind of a vehicle operation which corresponds to the support instruction; and
output the pseudo data on the vehicle operation to the sound data reproduction device by referring to the vehicle sound database based on the vehicle operation of the specified kind.

8. A method of supporting traveling of a vehicle by a remote support device, the method comprising the steps of:
obtaining data on ambient sounds of the vehicle;
separating the data on an ambient sound into data on a vehicle sound which represent a sound produced accompanying an operation of the vehicle and data on an environmental sound which represent a sound produced in an environment around the vehicle; and
outputting the data on the environmental sound from a sound data reproduction device of the remote support device.

9. The method according to claim 8, the method further comprising the steps of:
generating a support instruction for the vehicle in accordance with an input by an operator who performs the remote support;
specifying a kind of a vehicle operation which corresponds to the support instruction;
referring to a vehicle sound database, which stores pseudo data on vehicle sounds produced accompanying operations of the vehicle for each kind of vehicle operation, based on the vehicle operation of the specified kind; and
reading out pseudo data on the vehicle operation of the specified kind from the vehicle sound database and of reproducing the pseudo data from the sound data reproduction device.
